(19) United States
(12) Patent Application Publication
(10) Pub. No.: US 2006/0198134 A1
(43) Pub. Date: Sep. 7, 2006

(54) Fluorescent wall wash luminaire with a sliding mechanism for adjusting lamp position

(76) Inventor: Wilton LeGrand Fowler JR., Veradale, WA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/068,475

(22) Filed: Mar. 1, 2005

(51) Int. Cl. F21S 4/00

(52) U.S. Cl. 362/217

(57) ABSTRACT

A fluorescent wall wash luminaire has a housing with an opening for light generated by a fluorescent lamp to exit the housing. A portion of the housing forms an inclined base, and a socket pan holding a lamp socket for the fluorescent lamp is slidably mounted on the inclined base so that the socket pan may be moved along the inclined base between an upper position and a lower position. To move the socket pan, at least one lever arm and an adjustment slider are provided. The first end of the lever arm is pivotally attached to the housing and the second end of the lever arm is attached to socket pan. The adjustment slider has at least one slot and the lever arm extends through the slot. The slot in the adjustment slider is angled so that when the slider is moved, pressure is applied to the lever arm, thereby moving the socket pan. The amount and distribution of light emitted by the luminaire varies depending on the position of the socket pan along the inclined base, thereby providing the ability to adjust the distribution of emitted light.

### CROSS-REFERENCE TO RELATED APPLICATIONS

This application is related to application Ser. No. ______, which is entitled Fluorescent Wall Wash Luminaire With Adjustable Lamp Automatically Detented In Position By A Spring Latch, filed concurrently herewith, and invented by the same inventor, W. LeGrand Fowler, Jr. That application is hereby incorporated by reference in its entirety.

### FIELD OF THE INVENTION

The present invention generally relates to fluorescent luminaires. More specifically, the present invention relates to a fluorescent wall wash luminaire with a lamp that may be moved to adjust the light distribution pattern emitted by the luminaire.

### BACKGROUND OF THE INVENTION

One type of fluorescent luminaire is a wall wash luminaire. A wall wash luminaire typically includes a ceiling mounted housing which is mounted adjacent a vertical surface such as a wall. Fluorescent lamps and a specular reflector are located within the housing. The housing and the reflector are configured so that the majority of the light emitted by the lamps is directed towards the wall. One example of a wall wash luminaire is the FW102 luminaire that is commercially available from Columbia Lighting of Spokane, Wash.

In order to provide an even amount of lighting on an illuminated wall surface, it is desirable that the light emitted from the luminaire is emitted in an asymmetric pattern. This allows more light to be directed towards the portions of the wall which are further away from the luminaire.

One disadvantage of most wall wash luminaires is that the reflectors and the lamps are in a fixed position, and the light emitted by the luminaire is therefore emitted in a fixed pattern. This means that the luminaire must be mounted in a precise position in order to evenly light a desired surface. Often, however, it is not possible to precisely position a luminaire due to mounting requirements.

In order to address this disadvantage, there have been attempts to provide adjustable luminaires. Examples of adjustable luminaires are disclosed in U.S. Pat. No. 6,652,118 B2 to Shemitz et al., U.S. Pat. No. 5,803,585 to Littman et al., and U.S. Pat. No. 5,564,815 to Littman et al., each of which is hereby incorporated herein by reference in its entirety. Although the adjustable features of those luminaires eases the disadvantages described above, a continuing need exists for an improved fluorescent wall wash luminaire.

### SUMMARY OF THE INVENTION

One object of the present invention to provide a wall wash luminaire with an adjustable light distribution pattern.

Another object of the present invention is to provide a luminaire with a fluorescent lamp mounted on a movable base so that the lamp may be repositioned to adjust the light distribution pattern of the luminaire housing.

A further object of the present invention to provide a luminaire with a lamp which may be moved to adjust the pattern of light emitted by the luminaire.

Yet another object of the present invention is to provide a luminaire with a pair of lever arms for adjusting the position of an adjustable lamp.

The foregoing objects are basically attained by a fluorescent wall wash luminaire that has a housing with an opening for light generated by a fluorescent lamp to exit the housing. A portion of the housing forms an inclined base. A socket pan holding a lamp socket for the fluorescent lamp is slidably mounted on the inclined base so that the socket pan may be moved along the inclined base between an upper position and a lower position. To move the socket pan, at least one lever arm and an adjustment slider are provided. The first end of the lever arm is pivotally attached to the housing and the second end of the lever arm is attached to the socket pan. The adjustment slider has at least one slot and the lever arm extends through the slot. The slot in the adjustment slider is angled so that when the slider is moved, pressure is applied to the lever arm, thereby moving the socket pan. The amount and distribution of light emitted by the luminaire varies depending on the position of the socket pan along the inclined base, thereby providing the ability to adjust the distribution of emitted light.

Other objects, advantages, and salient features of the present invention will become apparent from the following detailed description, which, taken in conjunction with the annexed drawings, discloses preferred embodiments of the invention.

### BRIEF DESCRIPTION OF THE DRAWINGS

Referring to the drawings which form a part of this disclosure:

FIG. 1 is a perspective view of a luminaire according to an exemplary embodiment of the present invention with the socket pan located in an upper position;

FIG. 2 is a perspective view of the luminaire of FIG. 1 with the socket pan located in a lower position;

FIG. 3 is a side elevational view in cross-section taken along the line 3-3 in FIG. 1;

FIG. 4 is an exploded front elevational view of the front portion of the luminaire shown in FIG. 1;

FIG. 5 is an exploded front elevational view of the rear portion of the luminaire shown in FIG. 1;

FIG. 6 is an enlarged, sectional view of a positioning flange;

FIG. 7 is an enlarged, sectional view of the connection between the socket pan, the retaining plate, and the inclined base;

FIG. 8 is an enlarged, sectional view of a lever connection point;

FIG. 9 is a cross-sectional view taken along the line 9-9 in FIG. 8;

FIG. 10 is a perspective view of a specular reflector;

FIG. 11 is a front elevational view of a partial assembly of the luminaire shown in FIG. 1;

FIG. 12 is a side elevational view in cross-section taken along the line 12-12 in FIG. 11;

FIG. 13 is a front elevational view of a partial assembly of the luminaire shown in FIG. 1;

FIG. 14 is a side elevational view in cross-section taken along the line 14-14 in FIG. 13;

FIG. 15 is a front elevational view of a partial assembly of the luminaire shown in FIG. 1;

FIG. 16 is a side elevational view in cross-section taken along the line 16-16 in FIG. 15;

FIG. 17 is a front elevational view of a partial assembly of the luminaire shown in FIG. 1; and

FIG. 18 is a side elevational view in cross-section taken along the line 18-18 in FIG. 17.

### DETAILED DESCRIPTION OF THE INVENTION

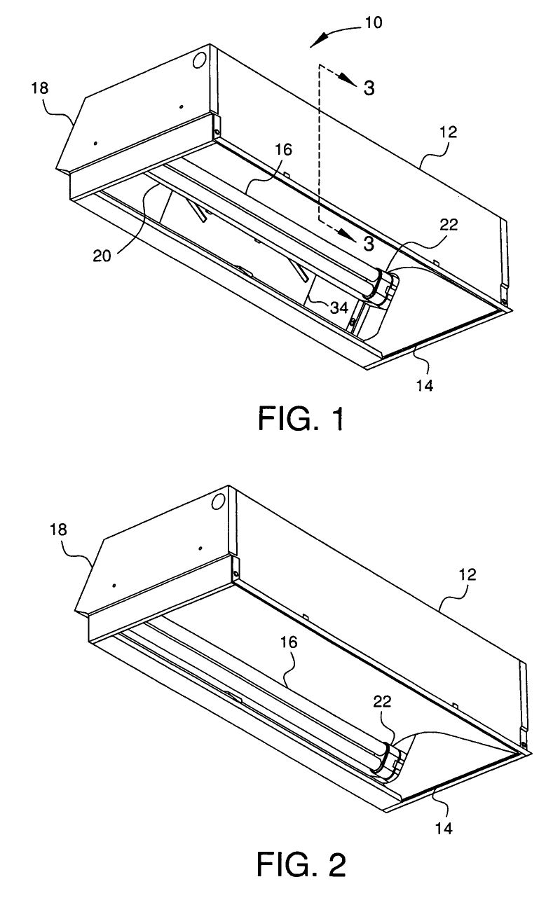

Referring initially to FIGS. 1 and 2, the fluorescent wall wash luminaire 10 of the present invention has a housing 12 with an opening 14 for light generated by a fluorescent lamp 16 to exit the housing. A portion of the housing forms an inclined base 18. A socket pan 20 holding a lamp socket 22 for the fluorescent lamp 16 is slidably mounted on the inclined base 18.

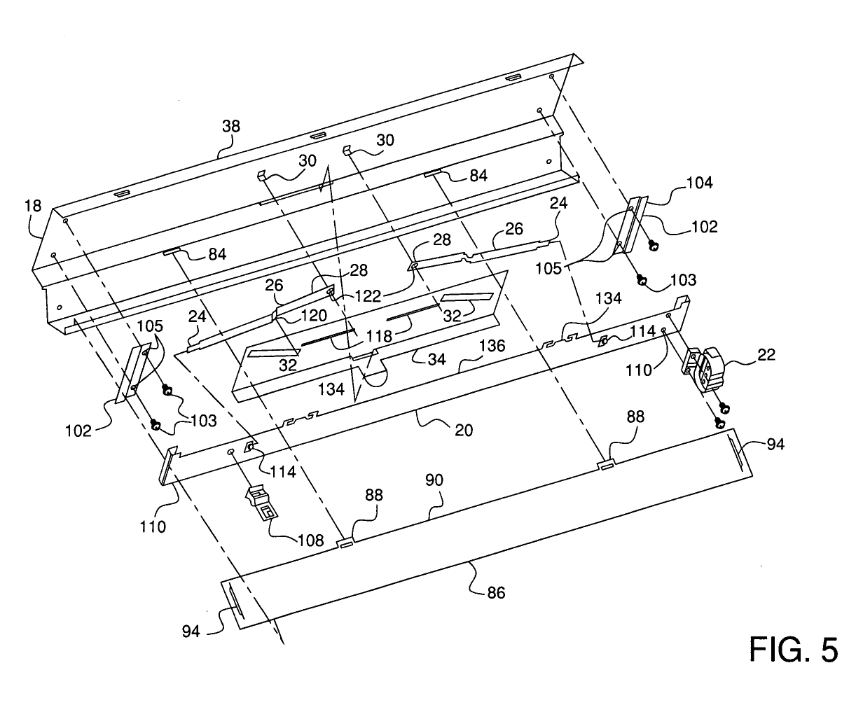

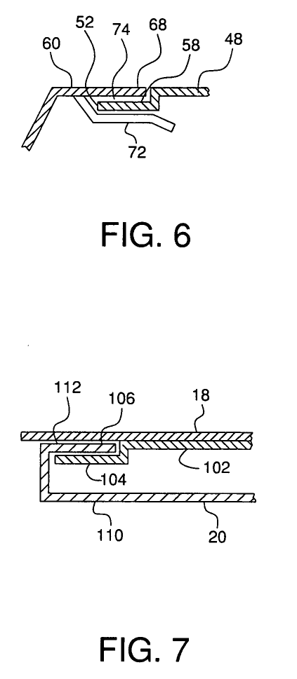

In operation, the position of the socket pan 20 may be adjusted by moving the socket pan 20 along the inclined base 18 from an upper position, shown in FIG. 1, to a lower position, shown in FIG. 2. To move the socket pan, a pair of lever arms 26 and an adjustment slider 34 are provided (as best seen in FIG. 5). The socket pan 20 is connected to the first end 24 of each of a pair of lever arms 26. The second end 28 of each of the lever arms 26 is pivotably attached to a tab 30 located on the inclined base 18. Each lever arm 26 extends through a slot 32 in an adjustment slider 34. Each slot 32 is angled so that as the adjustment slider 34 is moved horizontally, force is applied to the lever arms 26, thereby forcing the socket pan 20 to move either up or down. The amount and distribution of light emitted by the luminaire varies depending on the position of the lamp along the inclined base, thus providing the ability to adjust the distribution of light emitted from the luminaire.

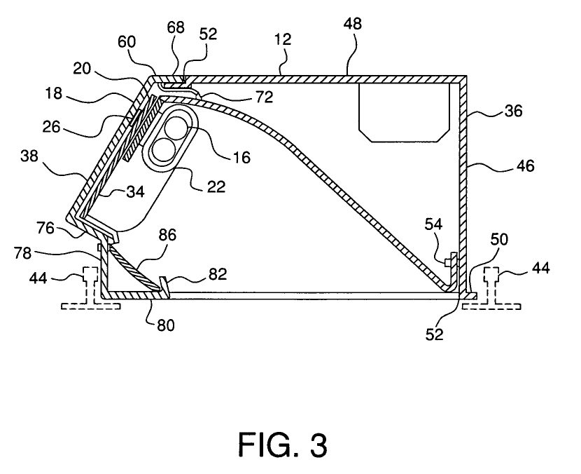

The luminaire housing 12 is preferably constructed of die-formed, code-gauge, cold-rolled steel and, as best seen in FIGS. 1-5, is formed by a front housing portion 36, a back housing portion 38, a right end cap 40, and a left end cap 42. The luminaire housing 12 can be directly mounted to the surface of a supporting structure (such as a ceiling). Alternatively, as illustrated in FIG. 3, the fixture may be supported by a ceiling grid 44 (indicated in dashed lines).

The front housing portion 36 forms the front wall 46 and top wall 48 of the housing 12. The front wall 46 and top wall 48 are preferably at a substantially right angle to one another. A lip 50 on the bottom edge 52 of the front wall 46 strengthens the edge and provides locations for mounting the housing to a supporting structure. Two tabs 54 extend generally perpendicular from the inside of the front wall. Preferably, the tabs are formed by punching the front wall of the housing to form the tab shape and folding the tab shape inward to form the tab. The back edge 52 of the top wall 48 is formed with an offset 58 so that it cooperates with the back wall 60 of the housing 12, as seen most clearly in FIG. 7.

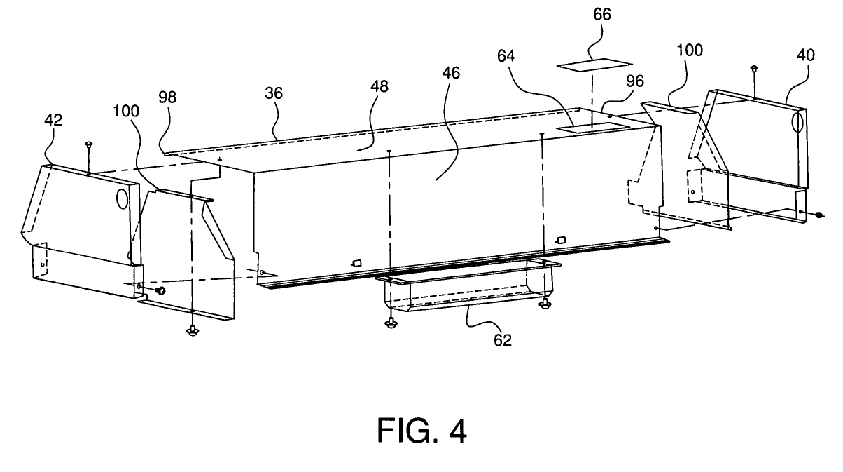

As best seen in FIG. 4, a ballast 62 is attached to the inside of the top wall 48 of the housing 12. The ballast is a conventional fluorescent lamp ballast and may be either electronic or magnetic as desired. Alternatively, several housings may be placed together in a master/slave arrangement with a single ballast located in the master fixture. An aperture 64 in the top wall 48 of the front housing portion 36 provides access to the ballast 62 and an access plate 66 covers the aperture 64 when not in use.

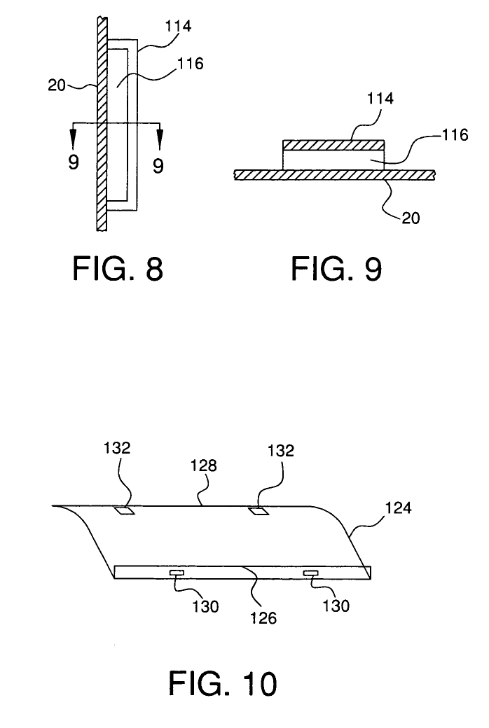

Returning to FIG. 3, the back housing portion 38 forms an inclined base 18 that is approximately 30° from vertical. An upper lip 68 is located at the top edge 70 of the inclined base 18. Three receiving flanges 72 are formed on the upper lip 68 and, as illustrated in FIG. 8, form a receiving groove 74. When the front housing portion 30 and back housing portion 32 are assembled, the offset edge 58 formed on the top wall 48 lies adjacent the upper lip 68 and is held in place within the receiving groove 74 formed by the three flanges 72.

A second wall 76 of the back housing portion 38 is preferably at a right angle to the inclined base 18, and a vertical wall 78 extends generally vertically. The second wall 76 and the vertical wall 78 are at an approximately 120° angle to one another. A base section 80 extends generally horizontally from the vertical wall 78 and terminates in a lower lip 82. Two slots 84 are formed near the intersection of the second wall and the vertical wall. As seen most clearly in FIG. 5, a generally rectangular lower reflector 86 has two tabs 88 extending from the top edge 90 which fit into the two slots 84 in the vertical wall 78. The lower edge 92 of the lower reflector 86 is retained by the lower lip 82 on the base section 80. Two stiffening ribs 94 are located on the reflector. The lower reflector 86 is preferably constructed of cold-rolled steel that is painted gloss white.

Turning to FIG. 4, the right hand end cap 40 and the left hand end cap 42 are attached to the left end 96 and right end 98 of the housing. The end caps are attached to the front and back housing portions 36 and 38 by any suitable means, such as screws. Specular reflectors 100 are located on the internal side of the end caps. The reflectors are preferably constructed of low iridescent specular anodized aluminum.

A pair of generally rectangular retaining plates 102 are generally flat with an offset portion 104. The plates 102 are mounted to the inclined base 18 by screws 103 that extend through mounting apertures 105 or by any other suitable fasteners. As shown in FIG. 7, when fastened to the inclined base 18, the offset portion 104 of the retaining plate forms a guide channel 106 between the retaining plate and the inclined base.

The lamp socket 22 is mounted on the socket pan 20, and is suitably and conventionally electrically connected to the ballast. The lamp socket 22 is a standard fluorescent socket base, such as a 2G11 base. A lamp support 108 is provided to support the end of the flourescent lamp 16. As best seen in FIG. 7, each of the longitudinal ends 110 of the socket pan 20 is generally U-shaped with a free arm portion 112. The free arm portion 112 fits into the guide channel 106 formed between the retaining plates 102 and the inclined base 18. The socket pan has two lever connection points 114, which are illustrated in more detail in FIG. 8-9. As seen there, the lever connection points 114 are generally U-shaped and form a pocket 116. An end 24 of a lever arm 26 fits into this pocket 116.

The adjustment slider 34 is generally shaped so that it fits into the angle formed between the inclined base 18 and the second wall 76. The adjustment slider 34 is horizontally shorter than the housing so that the slider 34 may be moved from side to side within the housing. The slider 34 has two lever slots 32 which are angled with respect to the longitudinal axis of the slider. In the illustrated embodiment, the angles are at an approximately 20° angle, but other angles may be chosen as desired. Two positioning slots 118 extend horizontally on the adjustment slider 34. The positioning slots 118 are located so that when assembled, the tabs 30 extend through the positioning slots 118 thereby supporting the adjustment slider so that it does not move in a vertical direction.

The two lever arms 26 each have a first end 24, a second end 28, and a middle portion 120. The first end 24 of each lever arm 24 has an aperture 122. The aperture 122 is sized so that it may be placed over one of tabs 30 located on the inclined base 18. The second end 24 of each lever arm 26 extends through one of the pockets 116 of the lever connection points 114 located on the socket pan 20. The lever arms 26 extend through the adjustment slots 32 in the adjustment slider 34 so that the middle portion 120 of the lever arms rests against the socket pan.

As seen in FIG. 10, a generally rectangular specular reflector 124 has a first edge 126 and a second edge 128. The first edge 126 of the reflector 124 is bent to form an angle and has two slots 130 located in it. The two slots 130 cooperate with the tabs 54 located on the front wall 46 of the housing 12 to hold the reflector in place. The second edge 128 of the reflector 124 has two retaining slots 132 as well. These retaining slots 132 cooperate with reflector retaining tabs 134 located on the top edge 136 of the socket pan 20 to fasten the reflector 124 to the socket pan 20. When the socket pan 20 is moved from an upper position to a lower position (or vice versa), the end of the reflector which is attached to the socket pan also moves, thereby changing the relationship between the lamp and the reflector.

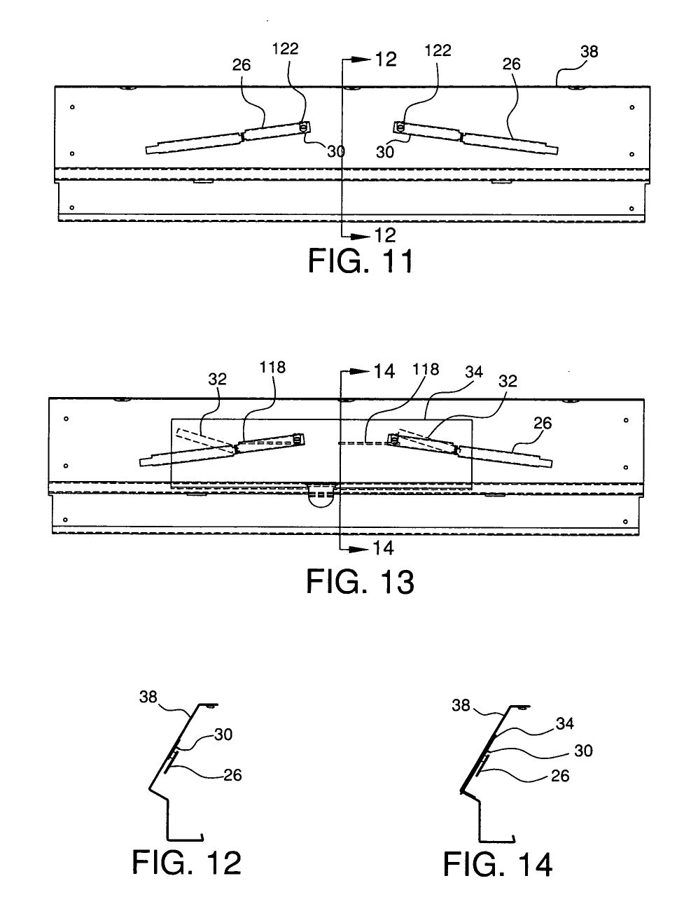

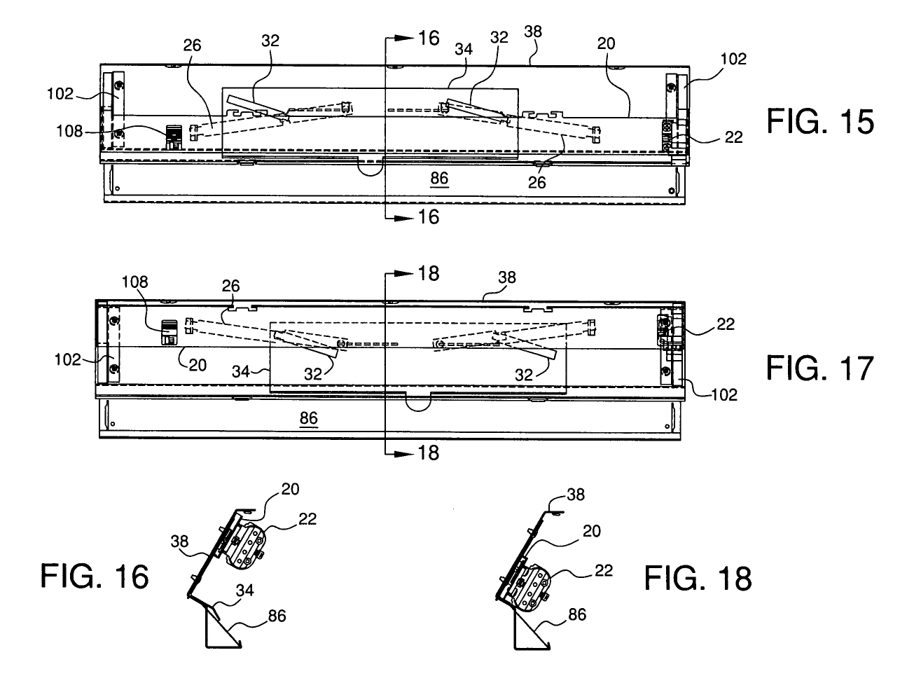

FIGS. 11-18 illustrate the construction of the luminaire of the exemplary embodiment of the invention described herein in further detail. FIGS. 11 and 12 illustrate the assembly of the lever arms 26 to the back housing portion 38. As seen there, the apertures 122 in the lever arms 26 are placed over the tabs 30 in the back housing portion 38. FIGS. 13 and 14 illustrate the assembly of the lever arms 26, the back housing portion 28, and the adjustment slider 34. As seen there, the positioning slots 118 in the adjustment slider 34 fit over the tabs 30, and the lever arms 26 extend through the slots 32 in the adjustment slider. FIGS. 15 and 16 illustrate the further assembly of the socket pan 20 (along with the lamp base socket 22 and lamp support 108), rectangular retaining plates 102, and generally rectangular lower reflector 86 to the assembly shown in FIGS. 13 and 14. In FIGS. 15 and 16, the socket pan is placed in a lower position. Finally, FIGS. 17 and 18 illustrate the assembly shown in FIGS. 15 and 16, with the adjustment slider moved to place the socket pan in an upper position.

While various embodiments have been chosen to illustrate the invention, it will be understood by those skilled in the art that various changes and modifications can be made therein without departing from the scope of the invention as defined in the appended claims.

What is claimed is:

1. A fluorescent luminaire, comprising:
a housing with an opening and an inclined base;
a socket pan slidably mounted on the inclined base, the socket pan having a lamp socket for receiving at least one fluorescent lamp;
an adjustment slider with at least one slot;
at least one lever arm with a first end, a middle section, and a second end, the first end of the lever arm being pivotally attached to the housing, the second end of the lever arm being attached to the socket pan, and the middle section extending through the at least one slot in the adjustment slider so that the socket pan moves when the adjustment slider is moved.

2. A fluorescent luminaire according to claim 1, further comprising
a specular reflector having a first, edge and a second edge, the first edge being attached to the socket pan and the second edge being attached to the housing.

3. A fluorescent luminaire according to claim 1, wherein
the lever arm is pivotally attached to the inclined plane.

4. A fluorescent luminaire according to claim 3, wherein
the socket pan is retained in a guide channel formed between a retaining plate and the inclined base.

5. A fluorescent luminaire according to claim 1, further comprising
a ballast attached to a top wall of the housing.

6. A fluorescent luminaire according to claim 1, wherein
the adjustment slider has a retaining slot to prevent movement of the adjustment slider in vertical direction.

7. A fluorescent luminaire according to claim 1, further comprising:
a specular reflector attached to the socket pan.

8. A fluorescent luminaire, comprising:
a housing with an opening and an inclined base;
a socket pan slidably mounted on the inclined base, the socket pan having a lamp socket for receiving at least one fluorescent lamp; and
means for adjusting the position of the lamp base on the inclined base.

9. A fluorescent luminaire according to claim 8, wherein
the means for adjusting the position of the lamp base comprises at least one lever arm cooperating with an adjustment slider.

10. A fluorescent luminaire according to claim 9, wherein
the lever arm is pivotably attached to the inclined base.

11. A fluorescent luminaire according to claim 10, wherein
the adjustment slider has at least one slot for cooperating with the lever arm.

12. A fluorescent luminaire according to claim 10, wherein
the socket pan is retained in a guide channel formed between a retaining plate and the inclined base.

13. A fluorescent luminaite according to claim 8, wherein
the socket pan has a pair of retaining tabs formed on the top edge; and
a specular reflector is attached to the retaining tabs on the socket pan.

14. A fluorescent luminaire, comprising:
a housing with an opening and an inclined base;
an adjustment slider with at least one adjustment slot;
a lever arm with a first end and a second end, the lever arm extending through the at least one slot, the first end of the lever arm being pivotably attached to the housing,
a socket pan having a lamp socket for receiving at least one fluorescent lamp, the socket pan being slidably retained in a guide channel formed between the housing and a retaining plate; the socket pan being connected to the second end of the lever arm so that when the adjustment slider is moved, the socket pan moves; and
a specular reflector having a first edge and a second edge, the first edge being attached to the socket pan and the second edge being attached to the housing.

15. A fluorescent luminaire according to claim 14, further comprising:
a ballast attached to a top wall of the housing.

16. A fluorescent luminaire according to claim 15, wherein the housing comprises
a front portion forming the front wall and top wall;
a rear portion attached to the front portion and forming the rear wall; and
end caps attached to the front and rear portion to form end walls.

17. A fluorescent luminaire according to claim 16, wherein
the luminaire is a lay-in luminaire for use with ceiling grids.

18. A fluorescent luminaire according to claim 15, wherein
the lamp socket is a 2G11 base.
